(19) United States
(12) Patent Application Publication
(10) Pub. No.: US 2015/0076007 A1
(43) Pub. Date: Mar. 19, 2015

(54) ELECTROCHEMICAL TEMPERATURE MEASUREMENT

(71) Applicant: Isis Innovation Limited, Oxford, Oxfordshire (GB)

(72) Inventors: Richard Guy Compton, Oxford (GB); Linhongjia Xiong, Oxford (GB)

(21) Appl. No.: 14/386,659

(22) PCT Filed: Mar. 15, 2013
(86) PCT No.: PCT/GB2013/050649

§ 371 Date: Sep. 19, 2014

(30) Foreign Application Priority Data
Mar. 20, 2012 (GB) 1204861.7

(51) Int. Cl. G01N 27/26; G01K 7/26

(52) U.S. Cl. CPC G01N 27/26; G01K 7/26
USPC 205/792; 205/793.5; 204/400

(57) ABSTRACT

An electrochemical method for measuring temperature, the method comprising •determining, at a temperature of interest, a first potential at which a first electrochemical reaction of a species occurs, •determining, at the temperature of interest, a second potential at which a second electrochemical reaction of the species occurs, •determining the difference between the first and second potentials, •converting the difference between the first and second potentials to a value of temperature. •Further provided is a temperature sensor for carrying out the method.

### FIELD OF THE INVENTION

The present invention relates to methods and devices for electrochemical temperature measurement, which can be used in the electrochemical sensing of gases, biological molecules, and other species.

### BACKGROUND

Amperometric chemical sensors find increasingly wide and diverse application for a variety of analytical targets (see references 1-3 at the end of the description; these references are each incorporated herein by reference in their entirety). Conspicuous successes include the development of disposable glucose sensors for diabetics (see reference 4, which is incorporated herein by reference in its entirety) and gas sensors of the Clark type (see references 5 and 6, which are each incorporated herein by reference in their entirety) for species including CO₂, O₂, H₂S, NOₓ, SOₓ, etc. (see references 7-12, which are each incorporated herein by reference in their entirety). The attraction of electrochemical sensors of this type is their high sensitivity and relatively low cost. In all cases, the sensors depend on a Faradaic electron transfer event at a solute-electrode interface driven by an applied potential and the resulting current gives the sought analytical signal.

While the current sensors work sufficiently well in many circumstances, they have limitations. For example, while many of the redox reactions that are monitored in the sensors are temperature dependent, the sensors are not necessarily calibrated with temperature or even able to monitor temperature. Even if temperature is measured with the current sensors, this is typically in a device separate from the electrodes monitoring the various redox reactions. It is therefore difficult to determine the actual temperature at the electrode surface at which the various redox reactions occur. It would be advantageous to provide an alternative to or an improvement on the current devices.

### BRIEF DESCRIPTION OF THE FIGURES

The Figures illustrate results from the Examples below.

FIG. 1 shows a cyclic voltammogram for the oxidation of bisferrocene in PmimNtf₂ on a platinum microdisc electrode at 298 K over a period of 15 hours.

FIG. 2 shows (a) a square wave voltammogram of the oxidation of bisferrocene over a temperature range of 298 K to 313 K; and (b) a plot of the peak difference as a function of temperature.

FIG. 3 shows a cyclic voltammogram for the oxidation of decamethylferrocene and TMPD in EmimTCB on a platinum microdisc electrode at 298 K.

FIG. 4 shows (a) a square wave voltammogram of the oxidation of decamethyl ferrocene and TMPD over a temperature range of 298 K to 313 K [Peak 1 is due to the oxidation of decamethylferrocene; peak 2 and peak 3 are the first and second oxidation of TMPD respectively (The chemical equations are described by Equations 1 to 3)]; and (b) a plot of the peak difference between peaks 1 and 3 as a function of temperature for the methods of the invention under vacuum.

FIG. 5 shows a square wave voltammogram for oxygen, decamethylferrocene and TMPD in EmimTCB at 298 K [Peaks a and b are due to the first and second electron transfer of oxygen].

FIG. 6 shows a plot of ΔE_{1/3} against temperature for the methods of the invention in the presence of dried pure oxygen.

FIG. 7 shows (a) experimental (solid line) and simulated (circles) chronoamperograms for the first reduction of pure oxygen in EmimTCB over a temperature range of 298 K to 318 K; and (b) a plot of ln D vs 1/T for oxygen, where T is the reading temperature obtained from the thermostat cage; and (c) a plot of ln D vs 1/T for oxygen where T is calculated from Equation 4.

FIG. 8 shows a plot of ΔE_{1/3} against temperature for the methods of the invention in the presence of dried air.

FIG. 9 shows (a) experimental (solid line) and simulated (circles) chronoamperograms for the first reduction of oxygen from the air in EmimTCB over a temperature range of 298K to 318K; and (b) a plot of ln D vs 1/T for oxygen where T is the reading values obtained from the thermostat cage; and (c) a plot of ln D vs 1/T for oxygen where T is obtained from ΔE_{1/3} conversion.

FIG. 10 shows a plot of concentration of oxygen against temperature for experiments in pure oxygen (dotted line), in the dried air (solid line) and the theoretically predicted value for the oxygen concentration (dashed line) [The triangles and squares are experimental values obtained from Shoup and Szabo fittings].

### SUMMARY OF THE INVENTION

In an first aspect, there is provided an electrochemical method for measuring temperature, the method comprising
determining, at a temperature of interest, a first potential at which a first electrochemical reaction occurs,
determining, at the temperature of interest, a second potential at which a second electrochemical reaction occurs,
determining the difference between the first and second potentials,
converting the difference between the first and second potentials to a value of temperature.

In a second aspect, there is provided a temperature sensor, wherein the sensor is adapted to
determine at a temperature of interest a first potential at which a first electrochemical reaction occurs,
determine at the temperature of interest a second potential at which a second electrochemical reaction occurs,
determine the difference between the first and second potentials,
convert the difference between the first and second potentials to a value of temperature.

In a third aspect, there is provides an electrochemical sensor for sensing a species, the sensor comprising
a working electrode, a counter electrode and a carrier medium in contact with the working electrode and the counter electrode, wherein the carrier medium contains, and/or the working electrode has immobilised on a surface thereof, one or more species, other than species to be sensed, that is or are capable of undergoing a first electrochemical reaction at a first potential, and a second electrochemical reaction at a second potential.

The present inventors have developed a method that can measure temperature using electrochemistry. The technique allows the temperature at working electrodes to be determined, which is useful in many situations. For example, in an electrochemical gas sensor the temperature of the working electrode (sometimes termed the sensor electrode) can be directly monitored, allowing the gas sensor to be accurately self-calibrated to temperature, and/or different electrochemical information to be obtained at different temperatures. The present inventors have found that the difference in potentials between two electrochemical reactions varies with temperature, generally in a linear manner, and therefore that the difference in potentials can be used to determine temperature.

### DETAILED DESCRIPTION

The present invention provides the first to the third aspects mentioned above. Optional and preferred features of the various aspects are described below. Unless otherwise stated, any optional or preferred feature may be combined with any other optional or preferred feature, and with any of the aspects of the invention mentioned herein.

The method involves determining, at a temperature of interest, a first potential at which a first electrochemical reaction occurs, and then
determining at the temperature of interest a second potential at which a second electrochemical reaction occurs.

The first electrochemical reaction may be an oxidation or a reduction of a first species. The second electrochemical reaction may be an oxidation or a reduction of a second species. Optionally, both first and second reactions are oxidations, i.e. requiring a positive potential to be applied (relative to an Ag reference electrode) to a working electrode in contact with the first species and/or second species to effect its/their oxidation. Optionally, both first and second reactions are reductions, i.e. requiring a negative potential to be applied (relative to an Ag reference electrode) to a working electrode in contact with the first species and/or second species to effect its/their reduction. Optionally, one of the first and second reactions is a reduction and the other is an oxidation.

The first species, in the first electrochemical reaction, may transform, by being oxidised or reduced, into the second species, which is then itself oxidised or reduced in the second electrochemical reaction. If this occurs, the first and second species will together be termed a single chemical entity herein. Alternatively, two different chemical entities will be oxidised or reduced in the first and second chemical reactions.

The first and second species may be either in a carrier medium, which may be as described below, or immobilised on a surface of a working electrode, which may be in contact with a carrier medium, e.g. an electrolyte. Likewise, the single chemical entity or two different chemical entities may be either in a carrier medium, which may be as described below, or immobilised on a surface of a working electrode, e.g., which may be in contact with a carrier medium, e.g. an electrolyte.

The first and second reactions may involve electrochemical oxidation or reduction of either (i) a single chemical entity, which undergoes a plurality of oxidations or reductions at different potentials or (ii) two different chemical entities, each of which undergoes an oxidation or reduction at a different potential from the other.

The first and second electrochemical reactions may involve electrochemical oxidation or reduction of a single chemical entity having three oxidation states, and, in the first electrochemical reaction, the single chemical entity undergoes a transition from a first oxidation state to a second oxidation state and, in the second electrochemical reaction, the single chemical entity undergoes a transition from the second oxidation state to a third oxidation state. If the single chemical entity undergoes a plurality of oxidations or reductions at different potentials, these may be at the same redox centre or at different redox centres within the chemical entity. The single chemical entity may, for example, have a redox centre, e.g. an organic group or an atom of an element, e.g. a metal, that can pass between three different oxidation states; this allows for a transition from a first oxidation state to a second oxidation state in the first reaction and a transition from the second oxidation state to the third oxidation state in the second reaction. The redox centre may comprise a transition metal that can have at least three oxidation states (including a 0 oxidation state, i.e. neutral state), optionally a metal having at least four oxidation states (including a 0 oxidation state, i.e. neutral state). The element may be a metal selected from, for example, the transition metals. The metal may be a transition metal that can have at least three oxidation states (including a 0 oxidation state, i.e. neutral state). Many transition metals have at least three oxidation states, including, but not limited to, transition metals of Groups 3 to 11 in the Periodic Table, including, but not limited to, first row transition metals such as titanium, vanadium, chromium, manganese, iron, cobalt, and copper; and second and third row transition metals, including, but not limited to, molybdenum, technetium, ruthenium, rhodium, palladium, tungsten, rhenium, osmium, iridium, platinum, and mercury. Many other elements have at least three oxidation states, including, but not limited to, elements from the groups 13 to 17 of the period table, including, but not limited to, phosphorous, sulphur, chlorine, gallium, germanium, arsenic, selenium, bromine, indium, tin, tellurium, iodine, thalium, lead, bismuth, polonium and astatine; and lanthanides and actinides, including, but not limited to, lanthanum, cerium, praseodymium, samarium, europium, gadolinium, terbium, dysprosium, thulium, and ytterbium. If the first or second reaction involves oxidation or reduction of an atom of an element, the element may form part of a complex or compound. Suitable complexes or compounds can be selected by the skilled person, depending on the purpose of, nature of and environment in which the first and second reactions are carried out.

In an embodiment, the single chemical entity comprises at least two redox centres, each centre undergoing an oxidation or reduction at a different potential from the other.

The single chemical entity may be a mixed valence compound, preferably a mixed valence compound of class II or class III, most preferably of class III, according to the Robin-Day classification. Mixed-valence compounds contain an element that can be present in more than one oxidation state, for example iron that is both in Fe(II) and Fe(III) states. Mixed-valence compounds of class II or class III show distinguishable potentials for the transition between the various oxidation states. Class III show the most distinction between the potentials of the various electrochemical transitions. The Robin-Day classification of mixed-valence compounds can be found, for example, in Inorganic Electrochemistry, Theory, Practice and Application (2003), authored by Piero Zanello and published by Royal Society of Chemistry, e.g. on pages 174 and 175, which is incorporated herein by reference in its entirety.

The single chemical entity may be an organic compound having two oxidisable or reducible groups or substituents linked via a delocalised electron system. For example, the single chemical entity may be an aryl compound having two oxidisable or reducible substituents on one or more rings of the aryl compound. The single chemical entity may, for example, comprise a phenyl moiety having two oxidisable or reducible substituents on the phenyl ring or a naphthyl moiety having two oxidisable or reducible substituents on one or both of rings of the naphthyl moiety. The two oxidisable or reducible substituents (before the first and/or second electrochemical reaction has been carried out) may be selected from, for example, N(R)₂ (wherein each R is alkyl, for example C1 to C10 alkyl, for example C1 to C5 alkyl, for example C1 to C3 alkyl, for example methyl, ethyl or propyl), amino, nitro, OH, COOH, —(C═O)H, —(C═O)R (wherein each R is alkyl, for example C1 to C10 alkyl, for example C1 to C5 alkyl, for example C1 to C3 alkyl, for example methyl, ethyl or propyl). The single chemical entity may comprise a phenyl compound having two oxidisable or reducible substituents, which may be in the ortho, meta or para positions on the phenyl ring relative to one another, and may be the same as or different from one another. The single chemical entity may comprise a phenyl compound having two oxidisable or reducible substituents para to one another, wherein the two oxidisable or reducible substituents (before the first and/or second electrochemical reaction has been carried out) may be selected from, for example, N(R)2 (wherein each R is alkyl, for example C1 to C10 alkyl, for example C1 to C5 alkyl, for example C1 to C3 alkyl, for example methyl, ethyl or propyl), amino, nitro, OH, COOH, —(C═O)H, —(C═O)R (wherein each R is alkyl, for example C1 to C10 alkyl, for example C1 to C5 alkyl, for example C1 to C3 alkyl, for example methyl, ethyl or propyl). The single chemical entity may, for example, comprise N,N,N′,N′-tetramethyl-p-phenylenediamine.

The single chemical entity may comprise an organometallic compound having two metal centres, each of which can be oxidised or reduced at a different potential from the other. The two metals of the two metal centre may be the same as or different to one another and selected from, for example, a transition metal, a lanthanide or actinide. In an embodiment, the single chemical entity comprises a metallocene compound comprising two metal centres.

In an embodiment, the single chemical entity may be a multiferrocene compound. A multiferrocene compound is a compound having a plurality of ferrocene groups, and is sometimes termed an oligoferrocene compound. Each of the cyclopentadienyl rings of ferrocene groups may have one or more substituents thereon. Each ferrocene group may be linked to another ferrocene group either directly via a covalent bond between a cyclopentadienyl ring of each ferrocene group or via a linker group covalently bonded to cyclopentadienyl ring of each ferrocene group. The multiferrocene compound may be selected from, for example, biferrocene, diferrocenylmethane, 1,2-bis(ferrocenyl)ethane (sometimes termed diferrocenylethane), diferrocenylethene (also termed 1,2-diferrocenyleththylene or bisferrocene) and diferrocenylethyne. Multiferrocene compounds are described, for example, in Inorganic Electrochemistry, Theory, Practice and Application (2003), authored by Piero Zanello and published by Royal Society of Chemistry, which is incorporated herein by reference in its entirety.

As mentioned, the first and second reactions may involve electrochemical oxidation or reduction of two different chemical entities, each of which undergoes an oxidation or reduction at a different potential from the other. The two different chemical entities may be termed first and second chemical entities. The first electrochemical reaction may involve an electrochemical oxidation or reduction of a first chemical entity, and the second electrochemical reaction may involve an oxidation or reduction of a second chemical entity, wherein the oxidation or reduction of the first chemical entity is at a different potential from the oxidation or reduction of the second chemical entity. The two different chemical entities may each be any appropriate chemical species that can undergo an oxidation or reduction at the temperature of interest. The chemical species may, for example, be selected from a metal compound or metal complex, wherein the metal of the metal compound or complex is oxidised or reduced in the first and/or second reaction; and an organic compound having one or more groups, wherein the one or more groups are oxidised or reduced in the first and/or second reaction. The metal of the metal compound or complex may be a metal having at least three oxidation states. The metal of the metal compound or complex may be a transition metal that can have at least three oxidation states (including a 0 oxidation state, i.e. neutral state), optionally a metal having at least four oxidation states (including a 0 oxidation state, i.e. neutral state). The metal may be selected from transition metals of Groups 3 to 11 in the Periodic Table, and optionally from the first, second or third row of Groups 3 to 11 in the Periodic Table. The metal may be selected from first row transition metals such as titanium, vanadium, chromium, manganese, iron, cobalt, and copper, and second and third row transition metals, including, but not limited to, molybdenum, technetium, ruthenium, rhodium, palladium, tungsten, rhenium, osmium, iridium, platinum, and mercury. The first chemical entity may be or may comprise a mixed valence compound, and the second chemical entity may be or may comprise a non-mixed valence compound, e.g. a non-mixed valence ferrocene. In an embodiment, the first chemical entity is selected from an organic compound having two oxidisable or reducible groups or substituents linked via a delocalised electron system, which may be as described above for the single chemical entity (e.g. N,N,N′,N′-tetramethyl-p-phenylenediamine), and multiferrocene compound, which may be as described above, and the second chemical entity is ferrocene compound different from the multiferrocene compound, e.g. a ferrocene compound containing a single iron atom; the ferrocene may be optionally substituted; the ferrocene may be a decaalkylferrocene, which alkyl is selected from C1 to C5, optionally from C1 to C3, optionally from C1 and C2, optionally from methyl, ethyl and propyl, optionally decamethylferrocene.

The first and/or second reaction is preferably a transition from one non-neutral oxidation state to another non-neutral oxidation state, for example from Fe(II) to Fe (III). The first and/or second reaction is preferably a reversible redox reaction.

The organic compound having one or more groups, which are oxidised or reduced in the first and/or second reaction may be any suitable organic compound. The organic compound may be a compound having oxidisable or reducible groups or substituents selected (before the first and/or second electrochemical reaction has been carried out) from, for example, N(R)₂ (wherein each R is alkyl, for example C1 to C10 alkyl, for example C1 to C5 alkyl, for example C1 to C3 alkyl, for example methyl, ethyl or propyl), amino, nitro, OH, COOH, —(C═O)H, —(C═O)R (wherein each R is alkyl, for example C1 to C10 alkyl, for example C1 to C5 alkyl, for example C1 to C3 alkyl, for example methyl, ethyl or propyl). The organic compound may be or may comprise a ferrocene. The ferrocene may be optionally substituted. The ferrocene compound may be a decaalkylferrocene, which alkyl is selected from C1 to C5, optionally from C1 to C3, optionally from C1 and C2, optionally from methyl, ethyl and propyl, optionally decamethylferrocene.

The potential of the first and second electrochemical reactions may be measured by any suitable technique. Typically, first and second potentials are measured using a voltammetry technique, which uses a working electrode, a counter electrode, and, if desired, a reference electrode. A potential may be applied between the working electrode and counter electrode, and the resulting current measured, using a potentiostat. The potential at which each of the first and second electrochemical reactions occurs may be the electrode potential of each of first and second electrochemical reactions. The electrode potential of the first and second electrochemical reactions may be determined using any suitable technique. The potential at which each of the first and second electrochemical reactions occurs may be the formal potential of each of the first and second electrochemical reactions. The formal potential may be measured using any suitable technique. In a preferred embodiment, the first and second potentials of the first and second electrochemical reactions are measured by a pulse voltammetry method, including, but not limited to sampled current polarography, differential pulse voltammetry, normal pulse voltammetry, and square wave voltammetry.

The first potential at which the first electrochemical reaction occurs may be determined by, for example, a voltammetry method, e.g. a pulse voltammetry method such as a square wave voltammetry method, in which a peak in current is seen at the first potential. Likewise, the second potential at which the second electrochemical reaction occurs may be determined by, for example, a voltammetry method, e.g. a pulse voltammetry method such as a square wave voltammetry method, in which a peak in current is seen at the second potential.

In an embodiment, the conditions for carrying out the square wave voltammetry use a frequency of from 0.1 to 100 Hz, optionally from 10 to 80 Hz, optionally from 40 to 60 Hz, optionally about 50 Hz; and/or a step potential of from 0.01 to 1 mV, optionally from 0.05 to 0.2 mV, optionally about 0.1 mV; and/or an amplitude of from 1 to 50 mV, optionally from 10 to 40 mV, optionally from 20 to 30 mV, optionally about 25 mV.

The method involves converting the difference between the first and second potentials to a value of temperature. This converting may be carried out by using a predetermined relationship between the difference between the first and second potentials and known temperatures, which may have been determined by a calibration step. The present inventors have found that the difference between the first and second potentials typically varies linearly with temperature, and that there is a high correlation between the two. Typically, the present inventors have found that the difference (E_{1/2}) between the first and second potentials can be represented by the formula (a)

E_{1/2}=C+nT formula (a)

where C is a constant and n is a coefficient, and T is temperature, and E_{1/2}=E₂−E₁, where E₁ is the first potential and E₂ is the second potential. With this relationship, for a system of interest, e.g. the temperature sensor and/or electrochemical sensor described herein, a calibration can be carried out for the first and second electrochemical reactions to determine values for E_{1/2} over a range of known temperatures to determine C and n. Accordingly, once C and n are known for a system, e.g. the temperature sensor and/or electrochemical sensor described herein, if E_{1/2} is determined at an (unknown) temperature of interest, a value T can be determined for the temperature of interest. In an alternative embodiment, if desired, higher order polynomials may be used for the relationship between the difference between the first and second potentials and temperature. For example, the relationship may be expressed by a second degree polynomial of formula (b)

E_{1/2}=C+nT+mT² formula (b)

wherein E_{1/2}, C, n and T are as defined above and m is a further coefficient. Again, for a system of interest, C, n and m may be determined in a calibration step by measuring E_{1/2} over a range of known temperatures. Higher degree polynomials relating E_{1/2} and T can also be used, such as third degree polynomials, fourth degree polynomials, and so on. However, in many circumstances, the relationship between E_{1/2} and T has been found to be sufficiently linear that formula (a) can be used and is adequate for temperature measurement.

The converting may be carried out automatically using an appropriate calculation medium, which may be a computer program. The computer program may be stored/distributed on a suitable medium, such as an optical storage medium or a solid-state medium supplied together with or as part of the temperature sensor and/or electrochemical sensor, but may also be distributed in other forms, such as via the Internet or other wired or wireless telecommunication systems.

In an alternative embodiment, the difference in the first and second potentials can be compared against a database containing calibrated values for differences between first and second potentials at a range of known temperatures, to give a value in the temperature of interest.

In an embodiment, the method involves a calibration step to determine a relationship between known temperatures and the difference in the potential between the potentials at which first and second reactions occur, and this relationship is used to convert the difference between the first and second potentials determined in the method to the value of temperature.

The calibration step may be an automatic calibration step carried out by the temperature sensor and/or electrochemical sensor.

The difference between the first and second potentials (e.g. at the temperature of interest or at 25° C.), is preferably at least 0.1 V, preferably at least 0.2 V, preferably at least 0.3 V, preferably at least 0.4 V, preferably at least 0.5 V, preferably at least 0.6 V, preferably at least 0.7 V, preferably at least 0.8 V, preferably at least 0.9 V, preferably at least 1 V. It has been found that the greater the difference between the first and second potentials, the greater the accuracy in the measurement of temperature using this difference. The first and second species being reduced in the first and second electrochemical reactions can be appropriately selected to increase the difference in potentials as desired.

The first and second reactions may be carried out in any suitable carrier medium, preferably an electrolyte. The first and second species that undergo the first and second electrochemical reactions may be dissolved or suspended in the carrier medium and/or immobilised on the surface of a working electrode, which may be in contact with a carrier medium. The carrier medium maybe a protic or non-protic solvent. Such a carrier medium may comprise a solvent. The solvent may be a polar or a non-polar solvent, dependent on the nature of the first and second species undergoing the first and second electrochemical reactions. The solvent may be a non-polar, non-protic solvent. In some examples the solvent may be selected from xylene, methylene chloride, perchloroethylene, chloroform, carbon tetrachloride, chlorobenzene, acetone, 2-butanone, 2-pentanone, methyl acetate, ethyl acetate, propyl acetate, butyl acetate, methyl propionate, ethyl propionate, a dialkylether of ethylene glycol wherein the alkyl groups contain 1 to 4 carbon atoms, a dialkylether of propylene glycol wherein the alkyl groups contain 1 to 4 carbon atoms, parafinnic solvents such as naphtha, hexane, benzene, toluene, diethyl ether, chloroform, and mixtures thereof. The solvent may comprise a protic solvent selected from water, alcohols, e.g. alkanols such as ethanol, and carboxylic acids.

The carrier medium may comprise a solid electrolyte. The solid electrolyte may comprise a protonic conductive electrolyte polymer. The solid electrolyte may be selected from a perfluorinated ion-exchange polymer, e.g. such as that available as Nafion, or a conductive polymer selected from poly(ethylene glycol), poly(ethylene oxide), poly(propylene carbonate).

In an embodiment, the first and second reactions are carried out in an ionic liquid. Generally, ionic liquids are non-aqueous, organic salts comprising ions where the positive ion is charge-balanced with a negative ion. Ionic liquids have low melting points, often below 100° C., undetectable or very low vapour pressure, and good chemical and thermal stability. The cationic charge of the salt is localized over hetero atoms, such as nitrogen, phosphorous, sulphur, arsenic, boron, antimony, and aluminium, and the anions may be any inorganic, organic, or organometallic species. The ionic liquid may be selected from, but is not limited to, imidazolium ionic liquids, pyridinium ionic liquids, tetra alkyl ammonium ionic liquids, and phosphonium ionic liquids. Imidazolium, pyridinium, and ammonium ionic liquids have a cation comprising at least one nitrogen atom. Phosphonium ionic liquids have a cation comprising at least one phosphorus atom. The ionic liquid may comprise a cation selected from alkyl imidazolium, di-alkyl imidazolium, and combinations thereof. In an embodiment, each of the alkyl groups independently contain from one to ten carbon atoms. Dialkyl imidazolium ionic liquids have a cation comprising two alkyl groups extending from a five membered ring of three carbon and two nitrogen atoms, most commonly from the two nitrogen atoms of this five membered ring; the two alkyl groups may each independently be selected from C1 to C10 alkyl groups, optionally from C1 to C6 alkyl groups, optionally from methyl, ethyl, propyl, butyl, pentyl and hexyl. In an embodiment, the dialkyl imidazolium ionic liquids have a 1-alkyl-3-methyl-imidazolium cation, wherein alkyl may be selected from C1 to C10 alkyl groups, optionally from C1 to C6 alkyl groups, optionally from methyl, ethyl, propyl, butyl, pentyl, hexyl, heptyl, octyl, nonyl and decyl. The ionic liquid cation may be selected from 1-methyl-3-methylimidazolium, 1-ethyl-3-methylimidazolium, 1-propyl-3-methylimidazolium, 1-butyl-3-methyl imidazolium, 1-pentyl-3-methyl imidazolium, 1-hexyl-3-methyl imidazolium, and combinations thereof.

In an embodiment, the ionic liquid may have an N-alkyl-pyridinium cation, wherein the alkyl is selected from C1 to C10 alkyl groups, optionally from C1 to C6 alkyl groups, optionally methyl, ethyl, propyl, butyl, pentyl, hexyl, heptyl, octyl, nonyl and decyl.

In an embodiment, the ionic liquid may have a tetraalkyl ammonium cation, wherein the alkyl is selected from C1 to C10 alkyl groups, optionally from C1 to C6 alkyl groups, optionally methyl, ethyl, propyl, butyl, pentyl, hexyl, heptyl, octyl, nonyl and decyl.

In an embodiment, the ionic liquid may have a tetraalkyl phosphonium cation, wherein the alkyl is selected from C1 to C10 alkyl groups, optionally from C1 to C6 alkyl groups, optionally methyl, ethyl, propyl, butyl, pentyl, hexyl, heptyl, octyl, nonyl and decyl.

In an embodiment, the ionic liquid comprises an anion selected from a borate (including, but not limited to, tetracyanoborate and tetrafluoroborate), PF₆, bistrifluoromethylsulfonylimide, halides, acetate, CF₃CO₂⁻, CF₃SO₂⁻, carboxylates, NO₃⁻ and combinations thereof.

In an embodiment, the ionic liquid is a room temperature ionic liquid, i.e. it is liquid at 25° C.

Optionally, the carrier medium, e.g. an ionic liquid, is within a solid support medium, preferably within the pores of a porous solid support medium. The solid support medium may comprise a mesoporous material, which may be a material having pores with a diameter in the range of from 1 to 75 nm, more particularly in the range of from 2 to 50 nm. The solid support medium may comprise a mesoporous material selected from zeolites, clays, and metal oxides, including, but not limited to, titanium oxide (TiO₂), aluminium oxide (Al₂O₃), zirconium oxide (zirconia, Zr₂O₄), and silicon oxide (silica, SiO₂), or mixtures thereof, such as silica-alumina.

The method may further involve obtaining further electrochemical information at the temperature of interest. For example, the method may further involve obtaining electrochemical information about a species, i.e. a species other than those involved in, e.g. oxidised or reduced in, the first and second reactions. A species other than those involved in, e.g. oxidised or reduced in, the first and second reactions may be termed a third species or a species to be sensed herein. The method may further involve determining the concentration of a species, which may be the same as or different from, the species involved in the first and second reactions, wherein the concentration is determined by electrochemical data; the determining of the concentration of the species may be carried out before, during or after determining the first and second potentials. The determining of the first and second potential may be carried out using a working electrode and a counter electrode in a voltammetry technique, and the working and counter electrodes are also used to obtain further electrochemical information at the temperature of interest.

The determining of the first and second potentials may be carried out using a working electrode and a counter electrode in a voltammetry technique, wherein the first electrochemical reaction involves oxidation or reduction of a first species and the second electrochemical reaction involves oxidation or reduction of a second species, wherein first and second species are in a carrier medium and/or immobilised on a surface of the working electrode in contact with the carrier medium, and the working and counter electrodes are also used to obtain further electrochemical information at the temperature of interest, including, but not limited to the concentration of a species in the carrier medium, e.g. a species other than the first and second species in the carrier medium.

In an embodiment, the method may be carried out in an electrochemical sensing device, e.g. an electrochemical gas sensing device. Electrochemical sensing devices are known to the skilled person. An electrochemical sensing device may be termed an electrochemical sensor. An electrochemical sensing device typically comprises a working electrode, a counter electrode and an electrolyte in contact with the working electrode and the counter electrode. The working electrode is sometimes termed a sensing electrode. The working and counter electrodes may be disposed opposite one another or the working and counter electrodes may be disposed on the same face of a substrate and spaced apart from one another. The electrochemical sensing device may further comprise a reference electrode. The working electrode, counter electrode, the electrolyte, and, if present, the counter electrode are typically in a housing. For electrochemical gas sensors, the housing typically comprises a means for controlling access of the gas to a counter electrode. The means for controlling access of the gas to the counter electrode may be a gas phase diffusion barrier, a Knudsen barrier or a solid membrane. Typically, in operation, a potential is applied between the working electrode and counter electrode, with the potential being varied as required, and the current monitored. The presence and concentration of the species to be sensed, e.g. a gas, within the electrolyte can be monitored using known relationships between the concentration of the species to be sensed, the potential applied between the working electrode and the counter electrode and the resulting current.

Electrochemical sensors are described, for example, in U.S. Pat. No. 5,668,302, EP0604012, U.S. Pat. No. 5,746,899, U.S. Pat. No. 5,746,899, WO 2007/100691, WO2005/017516, WO2008/110830, and WO 2008/057777, each of which is incorporated herein by reference in its entirety.

In an embodiment, the method is carried out in an electrochemical sensing device comprising a working electrode and a counter electrode, wherein the working electrode and counter electrode are used to determine the first potential at which the first electrochemical reaction occurs and the second potential at which the second electrochemical reaction occurs. The working and counter electrodes may also be used to obtain electrochemical information, about the species to be sensed, e.g. a gas, which may be used to determine the presence of and/or concentration of the species to be sensed within the sensor and/or in the ambient environment around the sensor; this may be before, during or after the first and second potentials have been determined.

The third species or the species to be sensed may be selected from glucose, NH₃, AsH₃, halogens (such as F₂, Cl₂, Br₂ and I₂), CO, CO₂, ClO₂, B₂H₆, GeH₄, H₂, HCl, HCN, HF, O₂, O₃, H₂S, nitrogen oxides (such as NO and NO₂), PH₃, SiH₄ and sulphur oxides (such as SO₂).

The present invention provides a temperature sensor for carrying out the method described herein. The present invention provides a temperature sensor, wherein the sensor is adapted to
determine at a temperature of interest a first potential at which a first electrochemical reaction occurs,
determine at the temperature of interest a second potential at which a second electrochemical reaction occurs,
determine the difference between the first and second potentials,
convert the difference between the first and second potentials to a value of temperature.

Preferably, the temperature sensor is also an electrochemical sensor for sensing and/or determining the concentration of a species within the sensor other than a species involved in the first and second reactions.

The temperature sensor may comprise working and counter electrodes, and an electrolyte in contact with the sensors, wherein, in use, the working and counter electrodes are used to determine the first and second potentials and obtain electrochemical information for sensing and/or determining the concentration of a species within the sensor other than a species involved in the first and second reactions. The electrolyte may be as described herein. The electrolyte may comprise an ionic liquid, which may be as described herein. The electrolyte may contain a chemical entity having three oxidation states, which may be as described herein, and, in use, in the first electrochemical reaction, the chemical entity undergoes a transition from a first oxidation state to a second oxidation state and, in the second electrochemical reaction, the chemical entity undergoes a transition from the second oxidation state to a third oxidation state.

The electrolyte may comprise two different chemical entities, which, in use, are either oxidised or reduced in the first and second electrochemical reactions, and the oxidation or reduction of the two different chemical entities occur at different potentials from each other.

The electrochemical sensor may also be or comprise a gas sensor. The gas sensor may be adapted to sense the presence and/or concentration of a gas selected from NH₃, AsH₃, halogens (such as F₂, Cl₂, Br₂ and I₂), CO, CO₂, ClO₂, B₂H₆, GeH₄, H₂, HCl, HCN, HF, O₂, O₃, H₂S, nitrogen oxides (such as NO and NO₂), PH₃, SiH₄ and sulphur oxides (such as SO₂).

The electrochemical sensor may be a pH sensor.

The electrochemical sensor may also be or comprise an electrochemical biosensor. The electrochemical biosensor may be for detecting one or more species of biological interest. The electrochemical biosensor may have a working electrode having probe molecules immobilised thereon for binding to a target. The probe molecules may be selected from, but are not limited to, one or more of a peptide, a peptide aptamer, a DNA aptamer, a RNA aptamer, and an antibody. The probe molecules may be selective for a target selected from, but not limited to, proteins, polypeptides, antibodies, nanoparticles, drugs, toxins, harmful gases, hazardous chemicals, explosives, viral particles, cells, multi-cellular organisms, cytokines and chemokines, ganietocyte, organelles, lipids, nucleic acid sequences, oligosaccharides, chemical intermediates of metabolic pathways and macromolecules.

The electrochemical sensor may be calibrated to take into account the value in temperature obtained by the temperature sensor when calculating the concentration of a species being sensed in the electrochemical sensor.

The invention further provides an electrochemical sensor for sensing a species, the sensor comprising
a working electrode, a counter electrode and a carrier medium in contact with the working electrode and the counter electrode, wherein the carrier medium contains, and/or the working electrode has immobilised on a surface thereof, one or more species, other than species to be sensed, that is or are capable of undergoing a first electrochemical reaction at a first potential, and a second electrochemical reaction at a second potential. The working electrode, counter electrode and carrier medium, which may be an electrolyte, may be as described herein. The one or more species may comprise a ferrocene compound. The electrochemical sensor is preferably adapted to carrying out the method of the first aspect as described herein.

The one or more species may comprise the single chemical entity described above or two different chemical entities, which may be as described above. The one or more species may comprise a mixed valence compound, which may be as described herein, e.g. selected from a multiferrocene compound, an aryl compound having a plurality of oxidisable or reducible substituents, and/or one or more non-mixed valence compounds, e.g. a non-mixed valence ferrocene, e.g. a ferrocene containing one iron atom per molecule.

The one or more species may comprise the first and second chemical entities described herein. The first chemical entity may be or may comprise a mixed valence compound, and the second chemical entity may be or may comprise a ferrocene, e.g. a non-mixed valence ferrocene. In an embodiment, the first chemical entity is selected from an organic compound having two oxidisable or reducible groups or substituents linked via a delocalised electron system, which may be as described above, and multiferrocene compound, which may be as described above, and the second chemical entity is a ferrocene compound different from the multiferrocene compound, e.g. a ferrocene compound containing one iron atom per molecule; optionally the ferrocene is substituted; optionally the ferrocene is a decaalkylferrocene, wherein alkyl is selected from C1 to C5, optionally from C1 to C3, optionally from C1 and C2, optionally from methyl, ethyl and propyl, optionally the ferrocene is decamethylferrocene.

In an embodiment, the carrier medium comprises an ionic liquid. The electrochemical sensor may also be a temperature sensor, as described herein, e.g. adapted to
determine at a temperature of interest the first potential at which the first electrochemical reaction occurs,
determine at the temperature of interest the second potential at which the second electrochemical reaction occurs,
determine the difference between the first and second potentials,
convert the difference between the first and second potentials to a value of temperature.

The electrochemical sensor and/or temperature sensor may comprise a separable device that can control the electrochemical sensor and/or temperature sensor such that it carries out the method described herein; the separable device may carry out the converting step as described herein. The electrochemical sensor and/or temperature sensor and/or separable device may contain an appropriate computer program for controlling the electrochemical sensor and/or temperature sensor and/or separable device, such that the method as described herein is carried out. The computer program may be on suitable hardware, firmware or other storage medium that may form part of the electrochemical sensor and/or temperature sensor and/or the separable device.

The electrodes described herein, e.g. for use in the method, temperature sensor and/or the electrochemical sensor, may be any suitable electrodes. Typically, a working and a counter electrode are used, and, optionally a reference electrode may be used in the determining of the potential of the first and second reactions and/or in the electrochemical sensing.

The shape and configuration of the electrodes is not particularly restricted. The electrodes may be in the form of points, lines, rings and flat planar surfaces. In an embodiment, the working electrode and the counter electrode are disposed opposite one another within a housing. In an alternative embodiment, the working and reference electrodes are disposed on the same face of a substrate. In an embodiment, the electrodes are disposed on the same face of the substrate and form an interlocking pattern.

The working and counter electrodes may have any appropriate size, e.g. a maximum distance across their face of from 1 to 1000 microns, optionally from 1 to 500 microns, optionally from 1 to 50 microns. The gap between the working and counter electrodes may be from 20 and 1000 microns, optionally from 50 to 500 microns.

The counter electrode and working electrode are optionally of equal size. Preferably, the surface area of the counter electrode is greater than that of the working electrode.

In the method, temperature sensor, and/or electrochemical sensor, the electrodes may each be supported on a substrate, which may form part of a housing optionally enclosing the electrodes and any carrier medium or electrolyte that is in contact with the electrodes. The substrate and/or housing may comprise any inert, non-conducting material, which may be selected from, but is not limited to, ceramic, plastic and glass.

The working, counter and, if present, reference electrodes each comprise any suitable electrically conducting material, e.g. a metal, an alloy of metals and/or carbon. The working, counter and, if present, reference electrodes may comprise a transition metal, for example a transition metal selected from any of groups 9 to 11 of the Periodic Table. The working, counter and, if present, reference electrode may each independently comprise a metal selected from, but not limited to, rhenium, iridium, palladium, platinum, copper, indium, rubidium, silver and gold.

Embodiments of the present invention will now be described with reference to the following non-limiting Examples and the accompanying drawings.

### EXAMPLES

In the following examples, Ferrocene (Fe(C₅H₅)₂, Aldrich, 98%), decamethylferrocene (Fe(C₁₀H₁₅)₂, Fluka, 95%), acetonitrile (MeCN, Fischer Scientific, dried and distilled, 99%), tetra-n-butylammonium perchlorate (TBAP, Fluka, Puriss electrochemical grade, 99%) 1-Ethyl-3methylimidazolium tetracyanoborate (“EmimTCB”; high purity, kindly donated by Merck) and 1-propyl-3-methylimidazolium bistrifluoromethylsulfonylimide (“PmimNtf₂” kindly donated by Queen's University, Belfast) were used as received without further purification. Oxygen (purity is greater than 99.5%) was purchased from BOC, Surrey, UK. N,N,N′,N′-tetramethyl-p-phenylenediamine (TMPD, Aldrich, 98%) was recrystallised from hot ethanol. 1,2-diferrocenyleththylene (Bisferrocene) was synthesized using the following method: TiCl₄ (0.39 mL, 3.50 mmol) was added dropwise to anhydrous THF (10 mL) at 0° C. under N₂. A solution of ferrocenecarboxaldehyde (500 mg, 2.34 mmol) in anhydrous THF (5 mL) and Zn powder (300 mg, 4.59 mmol) were sequentially added to the yellow solution at 0° C. The resultant black suspension was heated at reflux for 4 h. After cooling, the mixture was poured onto ice water (50 mL), and saturated aqueous NaHCO₃ (30 mL) was added. The resultant mixture was extracted with CH₂Cl₂ (3×30 mL). The organics were dried over MgSO₄ and concentrated in vacuo to give the title compound (340 mg, 73%) as a dark orange solid; δ_{H} (400 MHz, CDCl₃) 4.18 (10H, s, Cp), 4.33 (4H, s, Cp), 4.55 (4H, s, Cp), 6.18 (2H, s, CH═CH).

Also, in the following examples, all electrochemical experiments were performed using a computer-controlled PGSTAT30-Autolab potentiostat (Eco-Chemie, Netherlands). For experiments in MeCN, solutions were housed in a sealed glass vial, with a three-electrode arrangement consisting of a 5.05 μm diameter Pt working electrode, a silver wire reference electrode and Pt coil wire counter electrode. The platinum microdisk working electrodes were polished on soft lapping pads (Kemet Ltd., UK) using alumina powders (Buehler, Ill.) of sizes 1.0, 0.3 mm and 0.05 mm. The electrode diameters were calibrated electrochemically by analysing the steady-state voltammetry of a 2 mM solution of ferrocene in MeCN containing 0.1 M TBAP, using a diffusion coefficient for ferrocene of 2.30×10⁻⁵ cm² s⁻¹ at 298 K.¹⁴ The experiments involving ionic liquids were studied using a three-electrode arrangement, consisting of a 5.05 μm radius platinum working electrode and two 0.5 mm diameter silver wires acted as quasi-reference and counter electrode. The microelectrode was modified with a small section of disposable pipette tip to form a cavity on the electrode surface into which microlitre quantities of RTIL were added. The electrodes were housed in a T-cell (reported previously)¹⁵, specifically designed to allow samples to be studied under a controlled atmosphere. Prior to the addition of any gases, the whole system was degassed under vacuum for at least 2 hours to remove water.^{13, 16, 17} Gas was pre-dried through a drying column consisted of concentrated sulphuric acid and solid calcium. Before the electrochemical measurements, gas was run for 30 minutes to ensure equilibrium was established. For experiments excluding gases, the ionic liquid was constantly purged under vacuum during experimental analysis.

All experiments were performed inside a thermostatted box (previously described by Evans et al.)¹⁸ which also functioned as a Faraday cage. The temperature was maintained at 298 (±0.5) K.

Furthermore, in the following examples, chronoamperometric transients were recorded using a sample time of 0.001 s. After pre-equilibration for 300 s, the potential was stepped from a position of zero current to a chosen potential after the reductive or oxidative peak, and the current was measured for 0.5 s. It is noted the first few data points demonstrate non-Cottrellian behaviour due to extensive double layer charging. Therefore data points before 10 ms were discarded. The time dependency of current for a single n-electron diffusional process with no adsorption or coupled homogenous hevetes is described by the Shoup and Szabo Equation (Equation 1), which is within an error of 0.6% over all t. For an n electron process, the chronoamperometric response at a microelectrode can be described as

$$\begin{matrix} i = 4 nFrDef ( t ) \\ where & Equation 1 \\ f ( t ) = 0.7854 + 0.8862 \sqrt{\frac{{r}^{2}}{4 Dt}} + 0.2146 exp ( - 0.7823 \sqrt{\frac{{r}^{2}}{4 Dt}} ) & Equation 2\end{matrix}$$

where i is the current, F is the Faraday constant, n is the number of electrons transferred, r is the radius of the electrode, c is the bulk concentration, D is the diffusion constant in and t is the time. The calculations and parameters chosen behind this technique are discussed in detail in previous references.¹⁹⁻²¹

Using this analysis, the diffusion coefficient, D and solubility of Oxygen, c in EmimTCB can be simultaneously determined since n (n=1) is known. The fit between experimental and simulated results was optimised by fixing the radius of the Pt microelectrode, r, and allowing the software to iterate through various D and c values.

All experiments were repeated at least three times and the variation of all results (i.e. peak potential, concentration and diffusion coefficient) for the same experiment was less than 0.15%.

### Example 1

### Measurement of temperature by voltammetry on a single molecule 1,2-diferrocenyleththylene

As discussed earlier, the study of the oxidation of bisferrocene allows the measurement of temperature since it contains two oxidisable centres; the voltammetric peaks as discussed below, are more than 200 mV apart. Note that in the following the signals are measured against a Ag pseudo reference electrode. Whilst the potential of such electrodes is known to slightly drift,^{14, 22} the difference between the two voltammetric signals will be insensitive to this drift since the latter is much slower than the time taken for a voltammetric scan.

1 mM bisferrocene was dissolved in PmimNtf₂ and then the whole system was degassed under vacuum for 2 hours before experiment. FIG. 1 shows successive cyclic voltammetric responses for the oxidation of bisferrocene in PmimNtf₂ at a scan rate of 10 mV s⁻¹ over a period of 15 hours and 2 hours interval between scans. A 6.9% reduction of bisferrocene over 15 hours was found by analysis of the steady state current. This result indicates that bisferrocene remains in PmimNtf₂ for a long period of time.

The formal potentials of redox couples can be readily evaluated using square wave voltammetry (SWV) as this records the current difference in the oxidative and reductive direction as a function of staircase potential.^{23, 24} The peak potential in the square wave voltammetry is close to the formal potential of the redox couple studied.²⁵

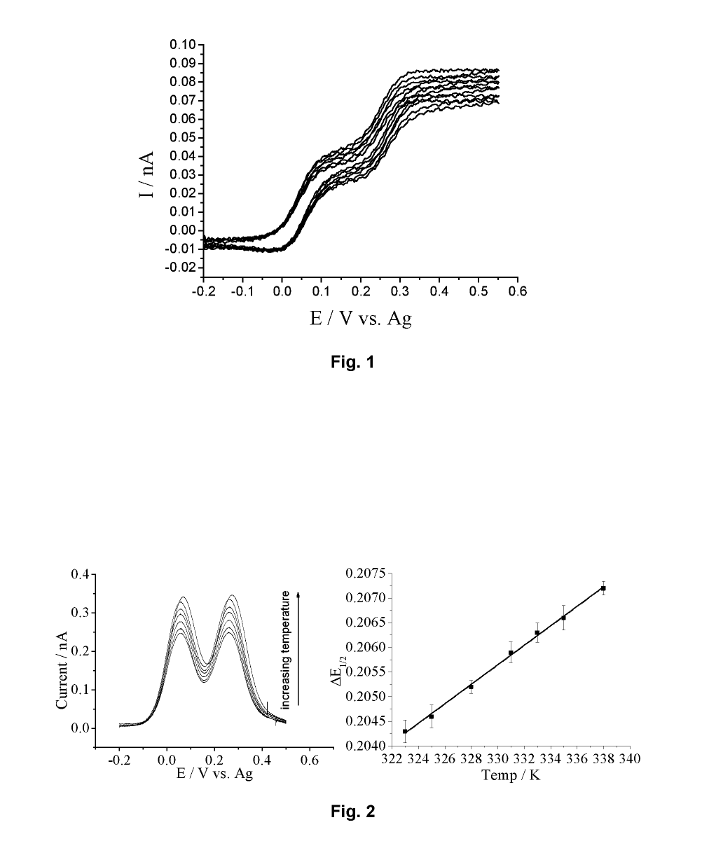

FIG. 2a shows the square wave voltammetry for the oxidation of bisferrocene in PmimNtf₂ over temperature range of 298 to 318 K. The optimised experimental conditions for SWV were achieved using a frequency of 50 Hz, a step potential of 0.1 mV and amplitude of 25 mV. As can be seen from this figure, the peak height increases with increasing temperature. This is because the diffusion rates are greater at higher temperature which leads to an increase in the square wave voltammetric current. There are two oxidative peaks at c.a 0.06 V and c.a 0.26 vs. Ag, which correspond to the following reactions:

Cp-Fe—C₅H₄—(CH═CH)—H₄C₅—Fe-Cp [symbol] Cp-Fe⁺—C₅H₄—(CH═CH)—H₄C₅—Fe-Cp+e⁻ Reaction 1:

Cp-Fe⁺—C₅H₄—(CH═CH)—H₄C₅—Fe-Cp [symbol] Cp-Fe⁺—C₅H₄—(CH═CH)—H₄C₅—Fe⁺-Cp+e⁻ Reaction 2:

The peak differences were measured via subtracting the peak potentials of these two oxidative waves in the square wave voltammetry at different temperatures. FIG. 2b displays the plot of the temperature dependence of the peak difference, ΔE_{1/2}. A linear correlation was obtained from the plot with R² of 0.997, gradient of 0.1976 (±0.0043) mV K⁻¹ and an intercept of 0.1405 V. This correlation can be expressed as follows,

ΔE_{1/2}=0.1405+0.198×10⁻³T Equation 3

where T is the temperature in K.

### Example 2

### Measurement of temperature by a decamethylferrocene-N,N,N′,N′-tetramethyl-p-phenylenediamine (TMPD) system

In order to obtain a more sensitive detection of temperature, it is necessary to consider a system with a larger temperature coefficient of peak difference. TMPD and decamethylferrocene were used due to their long-term stabilities in EmimTCB which were investigated using successive cyclic voltammetry for the oxidation of these two species over a period of 15 hours where 5.1% and 6.2% decrease from the original currents were observed respectively. TMPD, undergoing two electron transfers, together with decamethylferrocene acted as a temperature indicator where TMPD redox potential was recorded relative to the redox potential of decamethylferrocene at different temperatures.

1 mM decamethylferrocene and 5 mM TMPD were prepared in acetonitrile and 15 uL of each solution were then transferred into 15 uL EmimTCB. In order to remove acetonitrile and other impurities from EmimTCB, EmimTCB, containing decamethylferrocene and TMPD, was purged under vacuum for two hours. Decamethylferrocene-TMPD system was characterised using cyclic voltammetry.

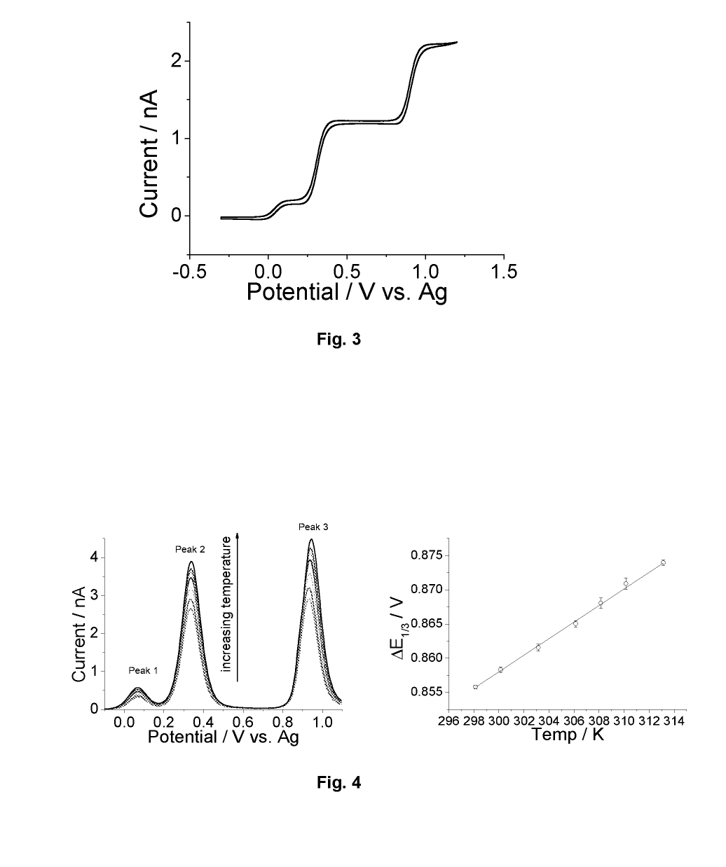

FIG. 3 shows the cyclic voltammetry of 1 mM Decamethylferrocene and 5 mM TMPD in EmimTCB recorded on a platinum electrode at 298 K over a potential range of −0.3 V to 1.2 V vs. Ag and at a scan rate of 10 mV/s. The oxidation of decamethylferrocene occurs at ca. 0.05 V vs. Ag whilst the first and second oxidation of TMPD are at c.a. 0.21 V and 0.92 V vs. Ag respectively. Reactions due to decamethylferrocene (DmFc) and TMPD are as follows,

DmFc [symbol] DmFc⁺+e⁻ Reaction 3

TMPD [symbol] TMPD′⁺+e⁻ Reaction 4

TMPD′⁺ [symbol] TMPD²⁺+e⁻ Reaction 5

FIG. 4a displays square wave voltammetry for 1 mM decamethylferrocene and 5 mM TMPD where the peaks marked with peak 1 to 3 are due to Reactions 3 to 5 respectively. In order to investigate the interactions between two redox couples, the system containing a single redox couple was voltammetrically compared with the system involving both compounds. The potential difference between the first and second oxidations of TMPD remained unchanged after the addition of decamethylferrocene. FIG. 4b represents the peak difference plotted against the ambient temperature where the peak difference, ΔE_{1/3}, was measured between peaks 1 and peak 3, and the temperature was read from the thermostat. ΔE_{1/3} was measured instead of any other peak pairs due to the fact that among the potential difference of all peak pairs, peak difference of peaks 1 and 3 showed the largest change in peak difference versus the temperature change. The graph in FIG. 4b yielded a gradient of 1.225±0.027 mV/K and an intercept of 0.4906±0.0082 V and the temperature can be related to the peak difference by the following equation:

ΔE_{1/3}=0.4906+1.225×10⁻³T Equation 4

### Example 3

### Investigation of Oxygen Under Pure Oxygen and Dried Air in the Decamethylferrocene-TMPD System

Next chronoamperometric measurements for the detection of oxygen were conducted at different temperatures using the voltammetric thermometer as a probe of the temperature. This example thus provides proof-of-concept of using the latter to calibrate amperometric sensors, for example of the Clark cell type.

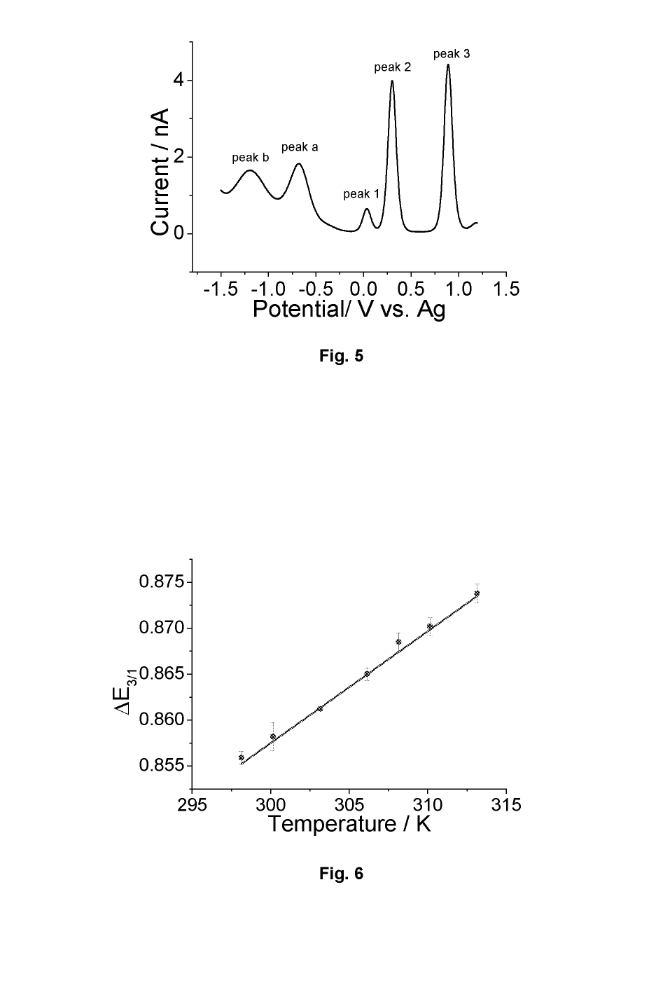

A system composed of decamethylferrocene and TMPD in presence of dried pure oxygen was also studied. It was observed that equilibrium was attained after passing oxygen through for 30 minutes. The decamethylferrocene-TMPD system under the dried oxygen was characterised using square wave voltammetry as shown in FIG. 5. The first two peaks (a and b) at lower potential correspond to Reactions 6 and 7 as shown below, whereas the other peaks are defined as Reactions 3-5.

O₂+e [symbol] O′₂⁻ Reaction 6

O′₂⁻+e [symbol] O₂²⁻ Reaction 7

FIG. 6 shows the change of the peak difference, measured between peak 1 and peak 3, with temperature, yielding a gradient of 1.220±0.029 mV/K and an intercept of 0.4917±0.0082 V, which is in good agreement with the results for the system in the absence of oxygen.

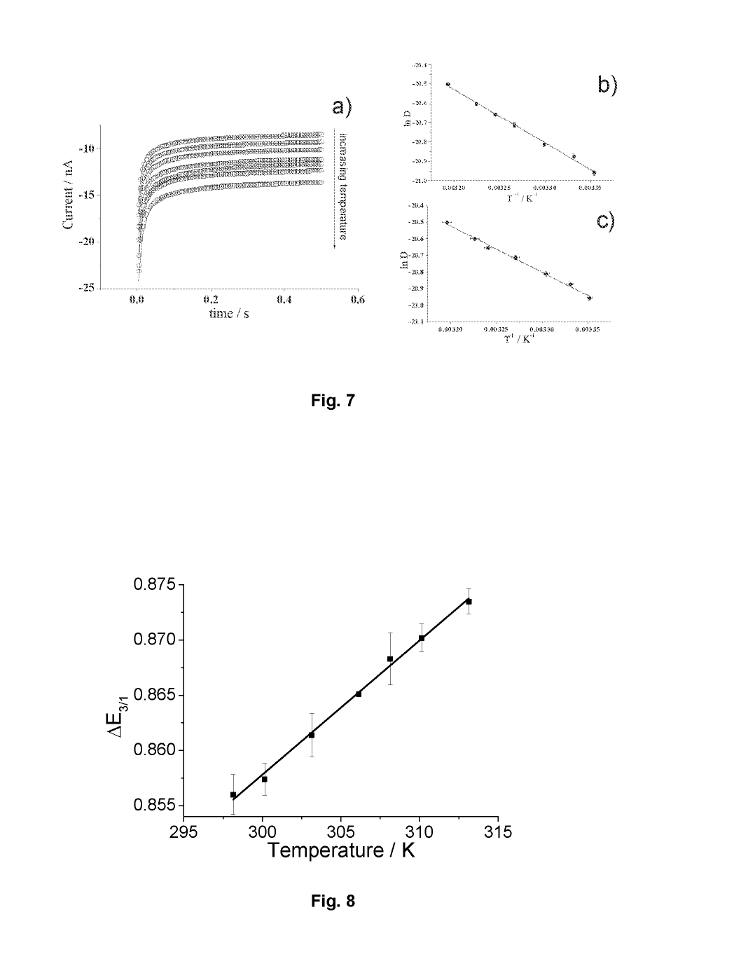

The concentration and diffusion coefficient of oxygen in EmimTCB at different temperatures were determined using potential step chronoamperometry which records the change of current as a function of time following a potential step from zero current to transport controlled currents. The current is initially very large due to the large concentration gradient in close vicinity to the electrode surface; then the faradaic current decreases and reaches the steady state due to depletion of the electro-active species near the electrode surface. FIG. 7a shows the experimental and simulated chronoamperometric responses for the one electron reduction of oxygen in EmimTCB containing decamethylferrocene and TMPD, where fittings of the experimental chronoamperometry were achieved using the Shoup and Szabo approximation (Equation 1) which was imported into a non-linear function in the software package Origin 8.1 (Microcal Software Inc.), where the radius of the electrode of 5.05 μL was fixed (previously calibrated) and the values of concentration, c, and diffusion coefficient, D, of oxygen were obtained via constructing the software to iterate through all possible values of c and D. The concentrations of oxygen obtained from the Shoup and Szabo approximation over the temperature range studied are listed as follows: 5.16 mM (298K), 5.19 mM (300K), 5.11 mM (303K), 5.27 mM (306K), 5.16 mM (308K), 5.22 mM (310K) and 5.23 mM (313K). These results remained almost constant with change of temperature which gave an averaged value of 5.19±0.01 mM. It is beneficial to have negligible variation of the solubility of oxygen with ambient temperature over the temperature range studied as the complexity of oxygen detection is largely minimised where the only variable changing with temperature is the diffusion coefficient of oxygen. The relationship of the diffusion coefficient and temperature is described via the Arrhenius Equation,

$$D = {D}_{∞} exp ( \frac{- {E}_{a , D}}{RT} ) \qquad Equation 5$$

and taking the natural logarithm of equation 4 yields,

$$ln D = constant - \frac{{E}_{a , D}}{RT} \qquad Equation 6$$

where D is the diffusion coefficient of oxygen, D_{∞} is the hypothetical diffusion coefficient at infinite temperature, E_{a,D} is the diffusional activation energy of oxygen and all other constant are defined as above.

FIG. 7b shows the Arrhenius plots of ln D with 1/T where T is the temperature read from the thermostat. In this plot, a line of best fit shows a high degree of correlation (R²>0.99) and gives a gradient of −2762.25 K. Combining this result and the Arrhenius Equation (Equation 5), the activation energy of diffusion, E_{a,D}, of oxygen, 23.0 kJ/mol, is determined. This value is comparable to the results reported in the literatures, where the values of E_{a,D} of oxygen range from 20 kJ/mol to 35 kJ/mol, depending on the viscosity and nature of the ionic liquid.²⁶ Temperature was also evaluated via the voltammetric thermometer by substituting the values of ΔE_{1/3} into Equation 4. FIG. 7c displays the plot of ln D against 1/T where T is obtained from the peak difference, ΔE_{1/3}, yielding a gradient of −2792.6 K (with R²>0.99) and E_{a,D} of 23.2 kJ/mol which is close to the value obtained in FIG. 8b. Hence it is concluded that the values of temperature calculated from ΔE_{1/3} and the voltammetric thermometer is reliable.

A similar experiment was repeated under the dried air instead of dried pure oxygen. The system in presence of dried air is characterised using square wave voltammetry which shows a similar response as depicted in FIG. 5. Peak difference, ΔE_{1/3}, is measured between peak 1 and peak 3. The reliability of representing T by ΔE_{1/3} is examined by the plot shown in FIG. 8, which gives a gradient of 1.215±0.035 mV/K and an interception of 0.4923±0.0072 V. This is in good agreement with the previous results (i.e. from FIGS. 4b and 6).

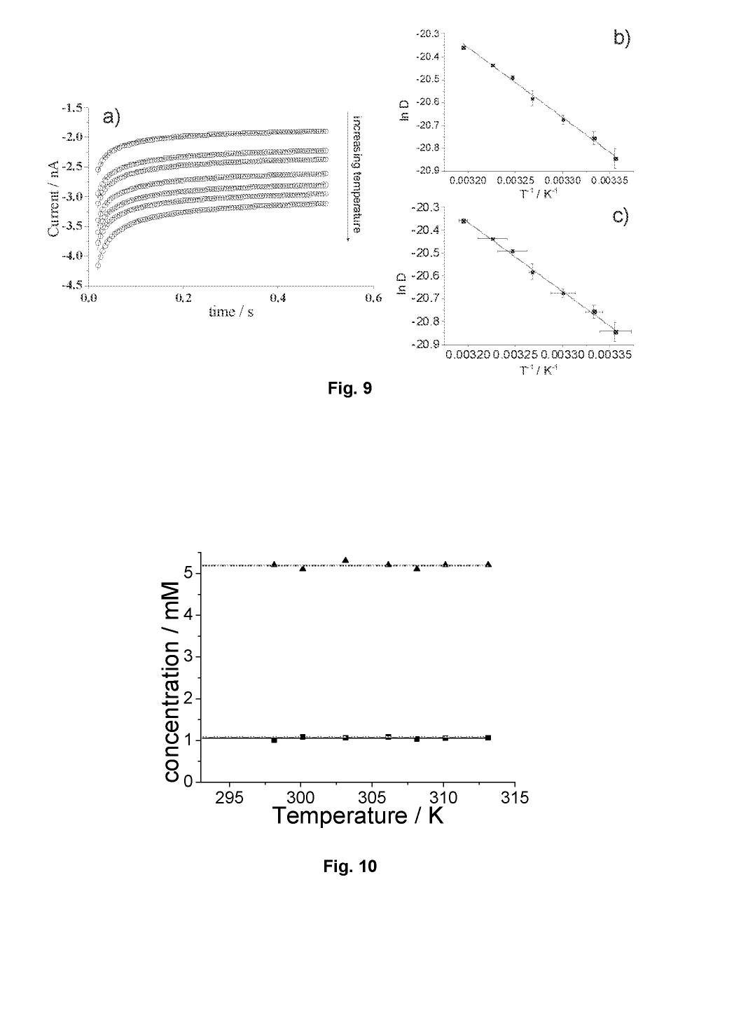

The diffusion coefficient and oxygen concentration were investigated using chronoamperometry. FIG. 9a compares the experimental and simulated chronoamperometry in the temperature range of 298 K to 313 K, where the fit between the simulated and experimental chronoamperometry all have a high correlation (R² is greater than 0.99). FIG. 9b shows the plot of ln D against 1/T with T read from the thermostat, producing a gradient of 3056.8 K which leads to a diffusional activation energy of 25.4 kJ/mol. This slightly higher activation energy of diffusion is probably due to a change in viscosity of EmimTCB caused by other gaseous components in the air.²⁷ FIG. 9c represents the Arrhenius plot of ln D with 1/T where T is obtained from Equation 4 by substituting the values of ΔE_{1/3}. The line of best fit gave a gradient of 3047.1 K, and consequently an activation energy, Eₐ of 25.3 kJ/mol.

FIG. 10 compares the concentration of oxygen obtained from pure oxygen and the dried air. It is known that dried air contains 20.9% (by mole fraction)^{28, 29} of oxygen and therefore an estimation of 79.1% reduction in the oxygen concentration is expected. It was experimentally determined that there is 5.19 mM oxygen in EmimTCB under pure oxygen and this dropped to 1.06 mM under the dried air, which is very close to the theoretical value predicted by the mole fraction of oxygen in air, 1.08 mM.

Through square wave voltammetric analysis of bisferrocene and decamethylferrocene-TMPD systems, these examples demonstrate the variation of difference in the peak potentials for two redox centres with temperature, which show temperature coefficients of 0.20 mV/K and 1.20 mV/K respectively. This temperature sensing system has been incorporated into a model oxygen sensor via investigating the latter system in the presence of oxygen either as pure oxygen or in dried air. It has been observed that the solubility of oxygen does not vary with temperature over the temperature range studied and c.a. 70.1% reduction of oxygen concentration from pure oxygen to dried air is in close agreement with the oxygen composition in air. Diffusion coefficient of oxygen has been studied as a function of temperature via an Arrhenius plot, which can be further related to the peak difference discussed previously. All of the examples were highly reproducible and a correlation of more than 0.99 indicated a high sensitivity towards sensing temperature.

### REFERENCES MENTIONED HEREIN OR OTHERWISE USEFUL FOR BACKGROUND

1. G. Hanrahan, D. G. Patil and J. Wang, Journal of Environmental Monitoring, 2004, 6, 657-664.
2. J. Wang, Analytical electrochemistry, Wiley-VCH, Hoboken, N.J., 2006.
3. J. P. Metters, R. O. Kadara and C. E. Banks, Analyst, 2011, 136, 1067-1076.
4. A. Heller and B. Feldman, Chemical Reviews, 2008, 108, 2482-2505.
5. L. C. Clark Jr and C. Lyons, Annals of the New York Academy of Sciences, 1962, 102, 29-45.
6. L. C. Clark, Jr., Transactions—American Society for Artificial Internal Organs, 1956, 2, 41-48.
7. M. J. Tierney and H. 0. L. Kim, Analytical Chemistry, 1993, 65, 3435-3440.
8. J. J. Horn, T. McCreedy and J. Wadhawan, Analytical Methods, 2010, 2.
9. R. G. Compton and R. J. Northing, Journal of the Chemical Society, Faraday Transactions, 1990, 86, 1077-1081.
10. L. Nei and R. G. Compton, Sensors and Actuators, B: Chemical, 1996, 30, 83-87.
11. N. S. Lawrence, L. Jiang, T. G. J. Jones and R. G. Compton, Analytical Chemistry, 2003, 75, 2499-2503.
12. F. G. Chevallier, T. J. Davies, 0. V. Klymenko, L. Jiang, T. G. J. Jones and R. G. Compton, Journal of Electroanalytical Chemistry, 2005, 577, 211-221.
13. M. C. Buzzeo, R. G. Evans and R. G. Compton, Chem Phys Chem, 2004, 5, 1106-1120.
14. E. I. Rogers, D. S. Silvester, D. L. Poole, L. Aldous, C. Hardacre and R. G. Compton, Journal of Physical Chemistry C, 2008, 112, 2729-2735.
15. U. Schröder, J. D. Wadhawan, R. G. Compton, F. Marken, P. A. Z. Suarez, C. S. Consorti, R. F. De Souza and J. Dupont, New Journal of Chemistry, 2000, 24, 1009-1015.
16. A. M. O'Mahony, D. S. Silvester, L. Aldous, C. Hardacre and R. G. Compton, Journal of Chemical and Engineering Data, 2008, 53, 2884-2891.
17. K. R. Seddon, A. Stark and M. J. Torres, Pure and Applied Chemistry, 2000, 72, 2275-2287.
18. R. G. Evans, 0. V. Klymenko, S. A. Saddoughi, C. Hardacre and R. G. Compton, The Journal of Physical Chemistry B, 2004, 108, 7878-7886.
19. C. A. Paddon, D. S. Silvester, F. L. Bhatti, T. J. Donohoe and R. G. Compton, Electroanalysis, 2007, 19, 11-22.
20. L. Xiong, L. Aldous, M. C. Henstridge and R. G. Compton, Analytical Methods, 2012, 4.
21. O. V. Klymenko, R. G. Evans, C. Hardacre, I. B. Svir and R. G. Compton, Journal of Electroanalytical Chemistry, 2004, 571, 211-221.
22. A. W. Bott, Current Separations, 1995, 14, 64.
23. R. G. Compton and C. E. Banks, Understanding voltammetry, Imperial College Press, 2^{nd} Edition, London, 2011.
24. A. J. Bard and L. R. Faulkner, Electrochemical methods: fundamentals and applications, Wiley India Ltd., New Delhi, 2006.
25. C. M. A. Brett and A. M. 0. Brett, Electrochemistry: principles, methods, and applications, Oxford University Press, Oxford, 1993.
26. X. J. Huang, E. I. Rogers, C. Hardacre and R. G. Compton, Journal of Physical Chemistry B, 2009, 113, 8953-8959.
27. L. E. Barrosse-Antle, L. Aldous, C. Hardacre, A. M. Bond and R. G. Compton, Journal of Physical Chemistry C, 2009, 113, 7750-7754.
28. D. J. Jacob, Introduction to atmospheric chemistry, Princeton University Press, Princeton, N.J., 1999.
29. I. N. Levine, Physical chemistry, McGraw-Hill, Boston, 2009.

Each of the above individual references is included herein by reference in its entirety.

We claim:

1. An electrochemical method for measuring temperature, the method comprising:
determining, at a temperature of interest, a first potential at which a first electrochemical reaction occurs;
determining, at the temperature of interest, a second potential at which a second electrochemical reaction occurs;
determining, with a processor, the difference between the first and second potentials; and
converting, with the processor, the difference between the first and second potentials to a value of temperature.

2. The electrochemical method according to claim 1, wherein the converting is carried out by using a predetermined relationship between the difference between the first and second potentials, and known temperatures.

3. The electrochemical method according to claim 1, wherein the converting is carried out by using the formula (a)
E_{1/2}=C+nT formula (a)
wherein E_{1/2} is the difference between the first potential (E₁) and the second potential (E₂), and C is a constant and n is a coefficient, with C and n having been determined in a calibration step, and T is the value in temperature.

4. The electrochemical method according to claim 1, wherein the first and second potentials are formal potentials determined by a pulse voltammetry method.

5. The electrochemical method according to claim 1, wherein the first and second potentials are determined by a square wave voltammetry method in which peaks in current are seen at each of the first potential and second potentials.

6. The electrochemical method according to claim 1, wherein the first and second electrochemical reactions involve electrochemical oxidation or reduction of a chemical entity having three oxidation states, and, in the first electrochemical reaction, the chemical entity undergoes a transition from a first oxidation state to a second oxidation state and, in the second electrochemical reaction, the single chemical entity undergoes a transition from the second oxidation state to a third oxidation state.

7. The electrochemical method according to claim 6, wherein the single chemical entity is a mixed valence compound.

8. The electrochemical method according to claim 7, wherein the mixed valence compound is selected from a multiferrocene compound and an aryl compound having a plurality of oxidisable or reducible substituents.

9. The electrochemical method according to claim 1, wherein the first and second electrochemical reactions involve oxidation or reduction of two different chemical entities, each of which undergoes an oxidation or reduction at a different potential from the other.

10. The electrochemical method according to claim 1, wherein the method is carried out in an electrochemical sensor.

11. The electrochemical method according to claim 10, wherein the method further comprises using the electrochemical sensor to sense and/or obtain information on the concentration of a species within the electrochemical sensor other than a species involved in the first and second electrochemical reactions.

12. The electrochemical method according to claim 11, wherein the electrochemical sensor has been calibrated such that it takes into account the value in the temperature when the concentration of the species, other than the species involved in the first and second electrochemical reactions, within the electrochemical sensor is calculated.

13. The electrochemical method according to claim 10, wherein the electrochemical sensor is selected from a potentiometric sensor, an amperometric sensor, a chemiresistor and a conductometric sensor.

14. The electrochemical method according to claim 10, wherein the electrochemical sensor is a gas sensor.

15. The electrochemical method according to claim 10, wherein the electrochemical sensor is an electrochemical biosensor.

16. A temperature sensor, wherein the sensor is configured to:
determine at a temperature of interest, a first potential at which a first electrochemical reaction occurs;
determine at the temperature of interest a second potential at which a second electrochemical reaction occurs;
determine the difference between the first and second potentials; and
convert the difference between the first and second potentials to a value of temperature.

17. A temperature sensor according to claim 16, wherein the electrochemical sensor for sensing and/or determining a concentration of a species within the sensor other than a species involved in the first and second electrochemical reactions.

18. A temperature sensor according to claim 17, wherein the electrochemical sensor and comprises working and counter electrodes, and an electrolyte in contact with the working and counter electrodes, wherein, in use, the working and counter electrodes are used to determine the first and second potentials and obtain electrochemical information for sensing and/or determining the concentration of a species within the sensor other than a species involved in the first and second reactions.

19. A temperature sensor according to claim 18, wherein the electrolyte comprises an ionic liquid.

20. A temperature sensor according to claim 18, wherein
(a) the electrolyte contains a chemical entity having three oxidation states, and, in use, in the first electrochemical reaction, the single chemical entity undergoes a transition from a first oxidation state to a second oxidation state and, in the second electrochemical reaction, the single chemical entity undergoes a transition from the second oxidation state to a third oxidation state, or
(b) the electrolyte comprises two different chemical entities, which, in use, are either oxidised or reduced in the first and second electrochemical reactions, and the oxidation or reduction of the two different chemical entities occur at different potentials from each other.

21. (canceled)

22. (canceled)

23. (canceled)

24. (canceled)

25. An electrochemical sensor for sensing a first species, the sensor comprising:
a working electrode having a first surface
a counter electrode; and
a carrier medium in contact with the working electrode and the counter electrode, wherein a second species that is capable of undergoing a first electrochemical reaction at a first potential, and a second electrochemical reaction at a second potential is contained by the carrier medium and/or is immobilized on the first surface of the working electrode.

26. (canceled)

27. (canceled)

28. (canceled)

29. (canceled)
